(19) United States
(12) Patent Application Publication
(10) Pub. No.: US 2012/0259675 A1
(43) Pub. Date: Oct. 11, 2012

(54) System and Method for a Retail Collaboration Network Platform

(76) Inventors: Louis F. Roehrs, Mountain View, CA (US); Patricia Avril England, Pleasanton, CA (US); Marc Dietz, San Francisco, CA (US); Armen L. Najarian, Palo Alto, CA (US); Samir H. Shah, San Jose, CA (US); Robert Parkin, San Francisco, CA (US); Suzanne Valentine, Atlanta, GA (US)

(21) Appl. No.: 13/083,378

(22) Filed: Apr. 8, 2011

(51) Int. Cl. G06Q 10/00

(52) U.S. Cl. 705/7.29

(57) ABSTRACT

The present invention relates to a system and method for a retail collaboration network platform. In some embodiments, the system and method for a retail collaboration network platform includes a portal which the user is able to log in to via a network. The system includes connectivity to a plurality of retailer and vendor analytic tools. These analytic tools may include tools for promotion analysis, price optimization, product assortment, and market analysis. In addition to analytic tools, the platform may include collaborative tools which may interface with the analytic tools. These collaborative tools enable retailers and vendors to work together and with partners to share information and develop and implement strategies based on analytic tools to achieve their respective business objectives. The collaborative tools may be enabled to create at least one workgroup, generate a contact list, monitor the workgroup and contact list for activity and display any such activity. Moreover, the activity may be sorted into actions and alerts and displayed as an activity feed and notification, respectively.

### BACKGROUND

The present invention relates to a system and methods for a business tool for a network platform for coupling various retailers and vendors to analytic merchandising and marketing tools that allow them to collaboratively develop strategies and tactics for optimized pricing for products, promotional event planning, product assortment, and other business decision making which impacts the profitability and market position of the retailers and vendors. This network allows retailers to interact with each other and with vendors for the purpose of improving their merchandizing and marketing activities through collaboration. This network platform may be stand alone, or may be integrated to include a pricing, promotion, markdown and assortment optimization systems to provide more effective sales of products, other 3^{rd} party analytic tools, and collaborative features.

For a retail or manufacturing business to properly and profitably function, there must be decisions made regarding product pricing, promotional activity, product assortment and display which, over a sustained period, effectively generates more revenue than costs incurred. In order to reach a profitable condition, the business is always striving to increase revenue while reducing costs.

One method of increasing revenues to both the retailer and the vendor is through the use of trade promotions. In these trade promotions, the vendor offers financial incentives to the retailer in return for promoting that vendor's products. As a part of the network platform, the vendor has the ability to electronically transmit deal terms for the promotion offer to the retailer. The retailer can then use promotion or pricing optimization tools on the network to evaluate the offer in terms of its own business objectives. The retailer can then either accept, reject or offer a counter-proposal back to the vendor electronically. Both the retailer and vendor may share sales and financial forecasts for the promotion from the network forecasting engine as a part of any transmission. Both the retailer and the vendor can forecast the impacts of each deal term. The can also create scenarios with differing deal terms and produce a shared sales forecast that can be used to project the financial benefits and costs of the promotion to their respective businesses.

One such method to increase sales revenue is via proper pricing of the products or services being sold. Additionally, the use of promotions may generate increased sales which aid in the generation of revenue. Likewise, costs may be decreased by ensuring that only required inventory is shipped and stored. Also, reducing promotion activity reduces costs. Thus, in many instances, there is a balancing between a business activity's costs and the additional revenue generated by said activity. This is true for both the retailer and the vendor. The key to a successful business is choosing the best activities which maximize the profits of the business.

Choosing these profit maximizing activities is not always a clear decision. There may be no readily identifiable result to a particular activity. Other times, the profit response to a particular promotion may be counter intuitive. Additionally, there are external market forces acting on demand for both the retailer's and vendor's products. Thus, generating systems and methods for identifying and generating business activities which allows the retailer to collaborate with other retailers or with their vendors or 3^{rd} parties analytics to produce strategies based on current market conditions and contains tools that allow them to evaluate and implement these strategies is a prized and elusive goal. Likewise, any system which provides greater insight into consumer behavior is highly sought after by retailers.

Currently, there are known systems and methods of generating product pricing through demand modeling and comparison pricing. In these known systems, product demand and elasticity may be modeled to project sales at a given price. Also known are systems and methods of promotion generation, product assortment and other retailer analytics. Typically these services are provided to the retailer ad hoc. Further, there tends to be a missing element of collaborative and social features associated with retailer analytics. The addition of social and collaborative features to an analytic framework provides the ability for pricing, promotion, assortment and buying decisions to be better rounded. This may lead to superior decision making by retailers and provide valuable insights to retailers and vendors alike.

It is therefore apparent that an urgent need exists for a retail value network platform which combines retail analytic tools and collaborative tools to enable retailers and vendors to make more informed decisions. This improved decision making enables retailers and their manufacturing vendor partners to realize greater profits and increased market share.

### SUMMARY

To achieve the foregoing and in accordance with the present invention, a system and method for a retail network platform is provided. In particular the system and methods for a retail network platform enables retailers and vendors greater access to business analytical tools and collaborative features which enables retailers to make better informed business decisions. This enables retailers to realize greater profits and increased market share.

In some embodiments, the system and method for a retail network platform includes a portal which the user is able to log in to via a network. The system includes connectivity to a plurality of retailer analytic tools. These analytic tools may include tools for promotion analysis, price optimization, product assortment, customer segmentation and market analysis.

In addition to analytic tools, the platform may include collaborative tools which may interface with the analytic tools. The collaborative tools may be enabled to create at least one workgroup, generate a contact list, monitor the workgroup and contact list for activity and display any such activity. Some examples of collaborative tools that may be used in concert with workgroups are threaded conversation streams, applications for group content creation, file and document repositories and scheduling and planning tools. Moreover, the activity may be sorted into actions and alerts and displayed as a activity feed and notification, respectively.

The workgroups may be created by the user, or may be selected by the user from a list of existing workgroups. Additionally, the workgroups may be editable. Moreover, key performance indicators associated with the workgroups may be displayed on the portal.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a high level schematic view of an embodiment of a system for enhanced business decisions which couples retailers to a retail value network, in accordance with some embodiment;

FIG. 2 is a schematic view of an embodiment of the retail value network platform, in accordance with some embodiment;

FIG. 3 is a schematic view of an embodiment of a network driver, in accordance with some embodiment;

FIG. 4 is a schematic view of an embodiment of a social and collaboration tool, in accordance with some embodiment;

FIG. 5A is an example flow chart for the operation of the retail network platform, in accordance with some embodiment;

FIG. 5B is an example flow chart for the operation of the collaboration tool, in accordance with some embodiment;

FIG. 6 is an example screenshot for the dashboard of the retail value network platform, in accordance with some embodiment;

FIGS. 7 to 10 are example screenshots for features of the collaboration tools of the retail value network platform, in accordance with some embodiment;

FIG. 11 is an example screenshot for a promotion analytic of the retail value network platform, in accordance with some embodiment;

FIG. 12 is an example screenshot for the application of collaboration tools within a promotion analytic, in accordance with some embodiment; and

FIGS. 13A and 13B illustrate a computer system, which forms part of a network and is suitable for implementing embodiments.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to a system and methods for a business tool for a network platform for coupling various retailers and vendors to analytic merchandising tools which include collaborative features to assist in the development of optimized pricing for products, promotional event planning, product assortment, and other business decision making which impacts the profitability of both the retailers and the vendors. This network platform may be stand alone, or may be integrated to include a pricing optimization system to provide more effective pricing of products, other analytic tools, and a collaborative feature.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. SYSTEM OVERVIEW

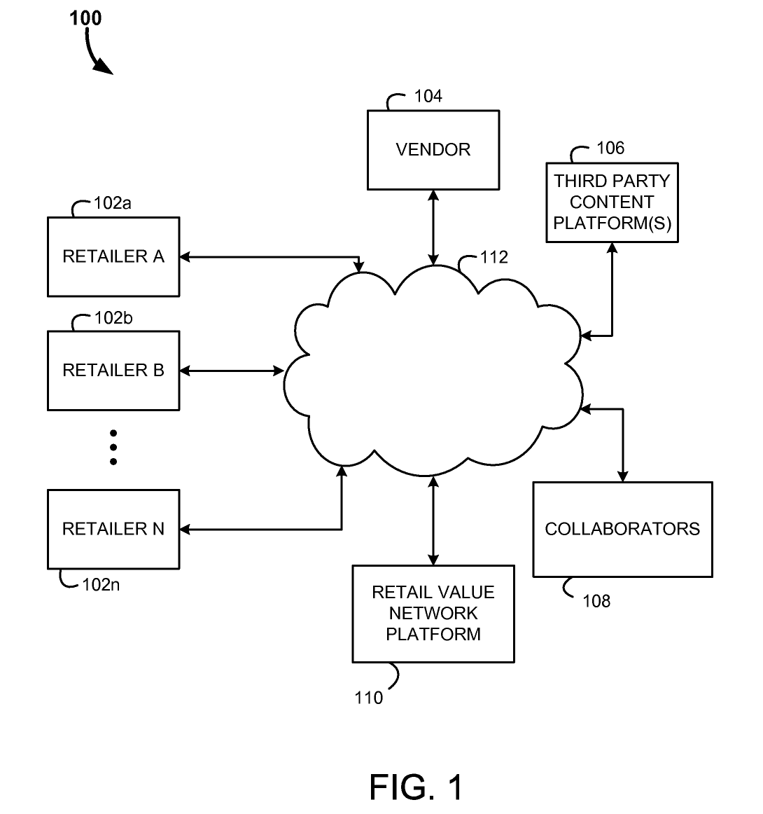

To facilitate the discussion, FIG. 1 is a high level schematic view of an embodiment of a system 100 for enhanced business decisions which couples retailers to an electronic retail value network, in accordance with some embodiment. In this example, illustration a plurality of retailers 102a to 102n are illustrated. These retailers 102a to 102n may include a Business to Consumer (B2C) type merchant. Examples of applicable retailers include large chains such as Wal-Mart™, Target™ and Safeway™, as well as smaller retailer outlets. In some cases, retailers 120 may also apply to Business to Business (B2B) type merchants. In some embodiments, the retailers 102a to 102n may include discrepant sectors, or may include direct competitors. Thus the scope of retailers 102a to 102n contemplated within the scope of this disclosure is intended to be very broad.

Each of the retailers 102a to 102n couples to a network 112. The network 112 may be a local area network (LAN) or a wide area network (WAN). An example of a LAN is a private network used by a mid-sized company with a building complex. Publicly accessible WANs include the Internet, cellular telephone network, satellite systems and plain-old-telephone systems (POTS). Examples of private WANs include those used by multi-national corporations for their internal information system needs. The network 112 may also be a combination of private and/or public LANs and/or WANs.

In some particular embodiments, the retailers 102a to 102n couple to the internet to gain access to a hosted application (i.e., network platform). The network platform is thus hosted on localized servers, but may be accessed via a secure network connection.

In addition to the plurality of retailers 102a to 102n, one or more vendors 104 may couple to the network 112. In some embodiments, the vendor(s) 104 provide products and/or services to the retailers 102a to 102n. Vendor services may include third party analytical services in addition to more traditional services (such as auditing and accounting). Moreover, in many cases the retailers 102a to 102n do not produce the products being sold. Rather, the vendors 104 produce, or distribute, the products being sold by the retailers 102a to 102n.

Third party content platforms 106 may likewise couple to the network 112. The third party content platforms 106 may include external analytical tools, news feeds, indexes, market condition and analysis data, or other relevant data or service.

Collaborators 108 may likewise couple to the network 112. Collaborators 108 may include any additional party which may access or contribute to the retail value network platform 110. Collaborators 108 could include, for example, trade associations, market analysts, retail or vendor software tool developers, etc. In some embodiments, any entity may be a collaborator, but a collaborator needs to be invited into a workgroup in order to have their applications and content available to the retailer.

Additionally, the retail value network platform 110 may access the network 112. Each of the retailers 102a to 102n, vendors 104, third party content platforms 106, and collaborators 108 may access the retail value network platform 110 via the network 112 in order to provide insights into product markets, access analytics for pricing and promotional analysis, and collaborative features.

In addition to the illustrated parties, additional contributors or users may access the retail value network platform 110, in some embodiments. These additional parties are not illustrated in the present figure for the sake of clarity. However, it is within the scope of some embodiments that more or fewer entities are coupled to the network 112.

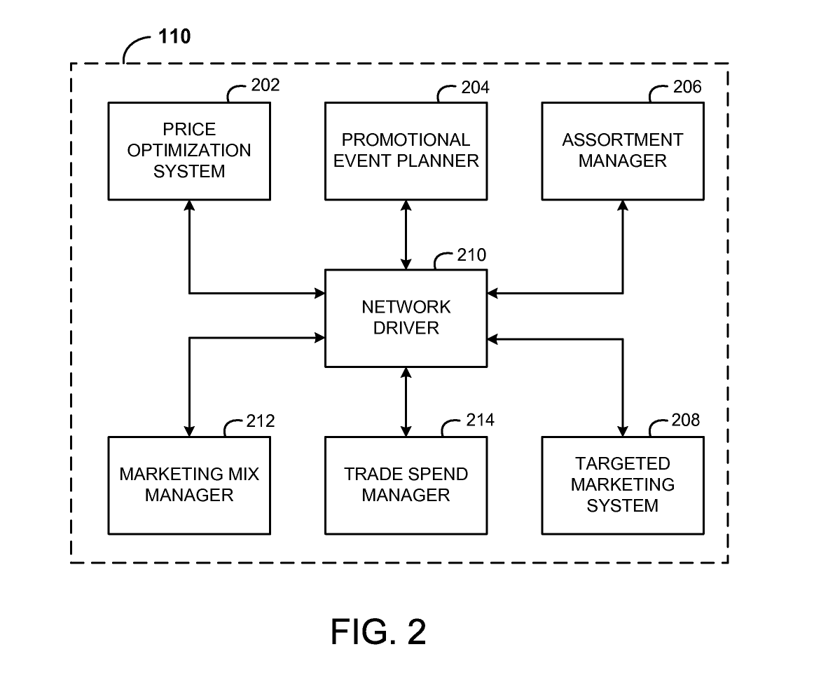

FIG. 2 is a schematic view of an embodiment of the retail value network platform 110, in accordance with some embodiment. In this example illustration a number of modules are seen coupling to a central network driver 210. The network driver 210 provides the core analytics which supports the activities of the other modules, in some embodiments. These modules may include a price optimization system 202, a promotional event planner 204, an assortment manager 206, a targeted marketing system 208, a trade spend manager 214, and a marketing mix manager 212. Of course, fewer or more analytic modules are considered within the scope of some embodiments.

One key analytic provided by the retail value network platform 110 is the price optimization system 202. Some embodiments of the price optimizing system 202 comprise an econometric engine, a financial model engine, an optimization engine, and a support tool. The econometric engine and financial engine may be connected to the optimization engine, so that their output is an input of the optimization engine. In some embodiments, the optimization engine is connected to the support tool. The econometric engine may also exchange data with the financial model engine.

Data is provided from the retailers 102a to 102n to the econometric engine for generation of demand models. Data may include Point-Of-Sale (POS) information, transaction log data, consumer id, product information, and store information. The data may also be processed (cleansed and aggregated by product, location and customer segment). Retailers 102a to 102n and vendor 104 information may be provided to the financial model engine for the generation of cost models. This data is generally cost related data, such as average store labor rates, average distribution center labor rates, cost of capital, the average time it takes a cashier to scan an item (or unit) of product, how long it takes to stock a received unit of product and fixed cost data.

The retailers 102a to 102n may use the support tool to provide optimization rules to the optimization engine. The optimization engine may use the demand equations/models, the cost model, the business rules, and retention data to compute an optimal set of prices that meet the rules. For example, if a rule specifies the maximization of profit across all segments, the optimization engine would find a set of prices that cause the largest difference between the total sales and the total cost of all products being measured. The optimization engine is able to forecast demand and cost for a set of prices to calculate net profit, as well as profit derived from each segment, profit lift by segment, and the like. If a rule providing a promotion of one of the products by specifying a discounted price is provided, the optimization engine may provide a set of prices that allow for the promotion of the one product and the maximization of profit under that condition. In this disclosure, the phrases “optimal set of prices” or “preferred set of prices” are defined as a set of computed prices for a set of products where the prices meet all of the rules. The rules normally include an optimization, such as optimizing profit or optimizing volume of sales of a product and constraints such as a limit in the variation of prices. The optimal (or preferred) set of prices is defined as prices that define a local optimum of an econometric model which lies within constraints specified by the rules When profit is maximized, it may be maximized for a sum of all measured products.

Note that other systems for the generation of optimized pricing are considered within the scope of some embodiments. Further, note that, in some embodiments, the network driver 210 may provide demand modeling, cost modeling, and additional customer insights for the generation of optimized pricing by the price optimizing system 202.

The promotional event planner 204 may, likewise, receive historical promotional effectiveness data from the retailers 102a to 102n, in conjunction with promotional costs, demand models, and other consumer insights, in order to formulate optimal promotional events. Promotional activity may be output from the promotional event planner 204 as a promotional calendar, or other promotional schedule.

The assortment optimization system 206 may utilize product demand, consumer insights, and knowledge of the products in order to determine the optimal assortment of products within a particular retailer 102a to 102n. The assortment manager 206 may be able to generate markdown schedules intended to eliminate stock of discontinued products, and provide for the purchase of replacement products. In some embodiments, the assortment planner may likewise assist in product placement/display decisions. In other embodiments, markdown may constitute a separate application which may be utilized in conjunction with the assortment and optimization system.

The targeted marketing system 208 may utilize transaction log data with identified customers to optimize the effectiveness of advertising campaigns targeting specific customers or customer segments. Some examples of targeted ad campaigns include direct mail advertising, email advertising and targeted advertising on web sites based upon user profiles. This tool utilizes customer identified transaction log data in a prediction tool that uses mathematical model to predict a specific customer's propensity to purchase a given set of products over a relevant time period. The optimization tool utilizes the predictions from the modeling tool to create a list of individual customers with the highest propensity to purchase the given set of products. This set of customers can then be exported into a vendor or retailers ad planning system to deliver the advertising to the targeted consumer.

The trade spend manager 214 may use POS data, trade execution data as well as financial data. POS data describes sales volumes and prices of a variety of products by product, location and time period. Trade execution data describes the trade activities (displays, Feature Ads, discounts, coupons, floor graphics, etc.) executed by product, location and time period. Financial data describes both the cost of those activities as well as the cost and revenue of the product sold. The trade spend manager 214 uses that data in conjunction with a predictive model to:
simulate alternative business plans including alternative activity level and alternative cost parameters, providing predictions of business metrics associated with the alternative business plan (what-if analysis).
predict future business performance based on a business plan (forecasting).
optimize a business plan across a portfolio of different activities, locations and products using a mathematical optimization algorithm.

The marketing mix manager 212 may use POS data, trade and marketing execution data as well as financial data. POS data describes sales volumes and prices of a variety of products by product, location and time period. Trade and marketing execution data describes the trade and marketing activities (displays, Feature Ads, discounts, coupons, floor graphics, TV, Radio, Internet, Print, etc.) executed by product, location and time period. Financial data describes both the cost of those activities as well as the cost and revenue of the product sold. The marketing mix manager 214 is a visualization and graphical user interface that uses that data in conjunction with a predictive model to:
provide reports on historical business performance including elasticity reports, effectiveness reports for individual activities, volume contributions from individual activities, historical financial performance.
simulate alternative business plans including alternative activity level and alternative cost parameters, providing predictions of business metrics associated with the alternative business plan (what-if analysis).
predict future business performance based on a business plan (forecasting).
optimize a business plan across a portfolio of different activities, locations and products using a mathematical optimization algorithm.
compare predicted and optimized scenarios against business targets.

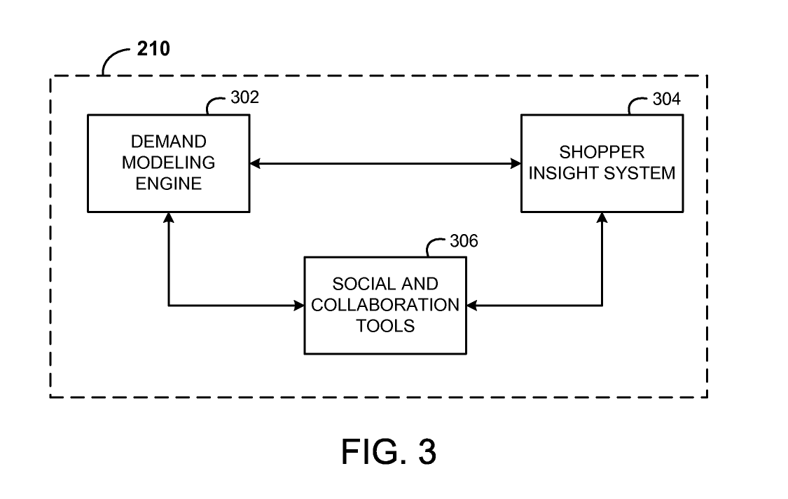

FIG. 3 is a schematic view of an embodiment of a network driver 210, in accordance with some embodiment. In some embodiments, the network driver 210 may include a demand modeling engine 302, a shopper insight system 304 and social and collaboration tools 306.

The demand modeling engine 302, in some embodiments, may replace, or be the same as, the econometric engine of the price optimization system 202. The demand modeling engine 302 generally received historical transaction data, including POS data, from the retailers 102a to 102n. The transaction data may be subjected to processing, including data error correction, data imputation, and aggregation by demand group. A demand group is defined, in this embodiment, as a grouping of highly substantial products. Trends in the quantity of products sold, dependent upon product price may be utilized using Bayesian statistics, or like modeling techniques, to generate demand models. The demand models may include one or more algebraic equations which relate the relative demand or products dependent upon product pricing. Additionally, the cross elasticity between products may be considered within the demand model.

The shopper insight system 304 provides shopper insights based upon transaction data which has been attributed to a known shopper. Identification data may be gained from loyalty type cards or programs, through payment data, self identification, or other methods of attributing the transaction to a particular buyer or household.

By linking transactions to identifiable households, and through aggregation of household transaction data by similar households, consumer insights for that grouping may be determined. These trends may buck global demand trends, and provides greater analytical granularity. They provide insights into what kinds of consumers are shopping in each store and what types of items they typically purchase together.

The social and collaboration tools 306 provide retailers the ability to communicate effectively within groups of related users. These related users may be within a singular retailer, or may span across various retailers 102a to 102n. Further, these features may enable users to track other's activity as well as news feeds in order to better inform business decision making.

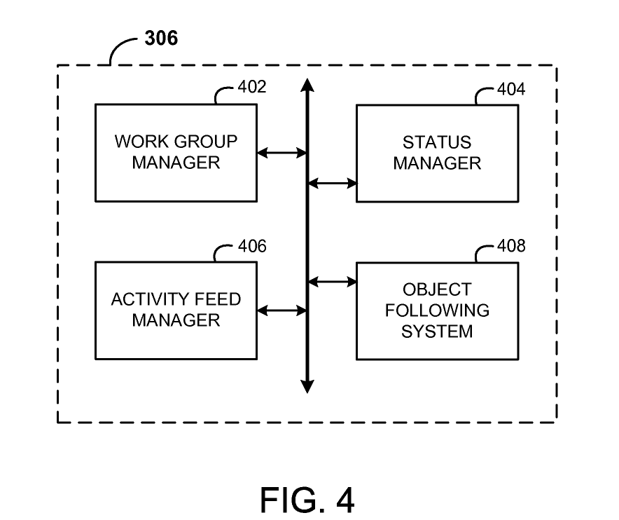

FIG. 4 is a schematic view of an embodiment of the social and collaboration tool 306, in accordance with some embodiment. In some embodiments, the social and collaboration tool 306 may include interconnected modules, including a work group manager 402, a status manager 404, an activity feed manager 406 and an object following system 408. The components of the social and collaboration tool 306 are known within the social networking technology sector, but have never before been effectively applied to the retail value sector. The retail value network platform 110 provides a fully integrated system for seamlessly incorporating social features with retail analytic tools in order to improve decision making ability of retailers and vendors.

The workgroup manager 402 enables a user to generate and join groups of individuals related by similar business interests. The status manager 404 enables the user to designate her status for other contacts to see. The activity feed manager 406 monitors and reports the status, comments and activities of other individuals in the user's group and other contacts. Likewise, relevant news may be provided by the activity feed manager 406. The object following system 408 may monitor designated objects and provide feedback to the user if status, price, or other condition changes.

### II. PROCESS FLOW

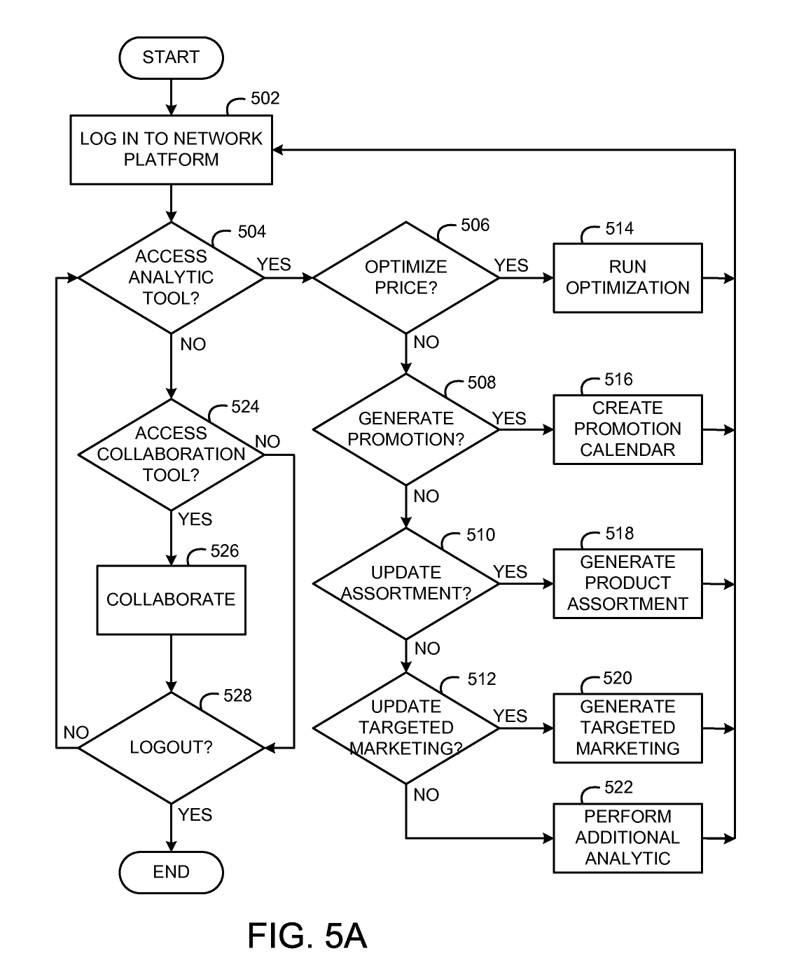

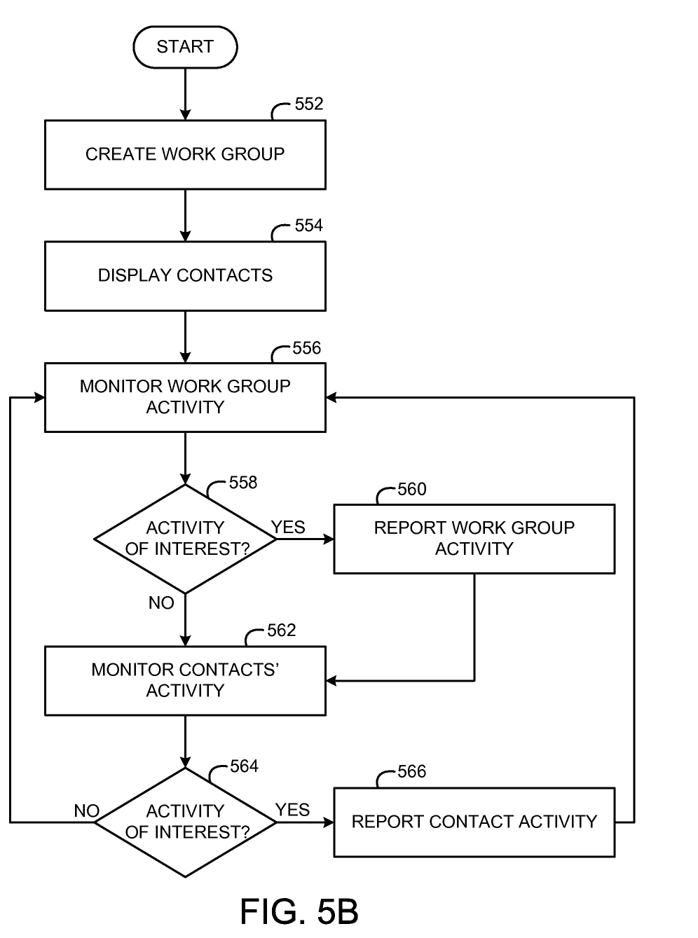

FIG. 5A is an example flow chart for the operation of the retail network platform 110, in accordance with some embodiment. In this example process flow, the user initially logs into the network platform (at 502) using any known login protocol. Typically, this includes the user providing a username and password via a logon page on a web browser. In some cases, the system may also require the usage of an electronic certificate, or media access control (MAC) address query, in order to provide an additional degree of security. In some embodiments, the retail network platform 110 is hosted on servers at a central location, and is accessible via a web portal from a computer system located at the retailer.

After logging in, in some embodiments, the user begins at her homepage in the application. Collaborative tools are made available at the homepage, enabling navigation to analytic tools or other collaborative tools. Thus, an inquiry is made if the user wants to access an analytic tool (at 504). This inquiry may be triggered by the user's actions. For example, in some embodiments, the analytic tools may be listed on a display as individual tabs. If the user selects on such tab, the system may recognize that the user wishes to perform an analytic. In such a case, the system may query which analytic is desired. The query may include optimization of prices (at 506), generation of promotions (at 508), update assortments (at 510), or updating targeted marketing (at 512). Once the proper analytic is identified it may be executed. This includes optimizing prices (at 514), generating promotion calendars (at 516), generating a product assortment (at 518), generating targeted marketing (at 520), or some other analytic (at 522). These additional analytics may include, in some embodiments, updating marketing mix, updating trade spend, display updates, etc. After the analytic activity is performed, the system may return to the network platform.

Additionally, if no analytic is desired, a query is made if the user wishes to access the collaboration tools (at 524). If so, the user selects one of the collaboration fields and performs a group update, tracks activities, updates preferences, updates status or posts a comment (at 526).

If the user is not accessing collaboration tools or analytic tools, then the system queries if the user wishes to logout (at 528). Logout may occur after a set time of user inactivity, or may occur if the user actively chooses to log off of the system. If the user logs out, the session may end, otherwise the system may return to inquiring if the user wishes to access an analytic tool.

FIG. 5B is an example flow chart for the operation of the collaboration tool, in accordance with some embodiment. In this example flow, the user first creates a workgroup (at 552). Workgroup creation may include generation of a workgroup from scratch, or joining an already existing workgroup. Workgroups typically connect users within a single retailer, or across various retailers or vendors, who share similar business interests, or have related jobs. Contacts of that user may also be displayed (at 554). Contacts may be populated with individuals from the workgroups, as well as personal contacts of the user. These contacts may include counterparts within other retailers, vendor contacts, or other individuals within the retailer.

Next, in some embodiments, the workgroup activity is monitored (at 556). If an activity of interest is detected in the workgroup (at 558), the workgroup activity may be reported to the user (at 560). Likewise, individual contacts of the user may be monitored (at 562). Contact monitoring includes monitoring contact status updates, comments and other activity. If an activity of interest is detected for a contact (at 564), the contact activity may be reported to the user (at 566). Likewise, but not illustrated, newsfeeds of interest may be monitored. Newsfeed monitoring may look for index updates, article updates, and may include keyword or syntactical monitoring. Relevant newsfeeds and industry content may be provided to the user as well.

### III. EXAMPLES

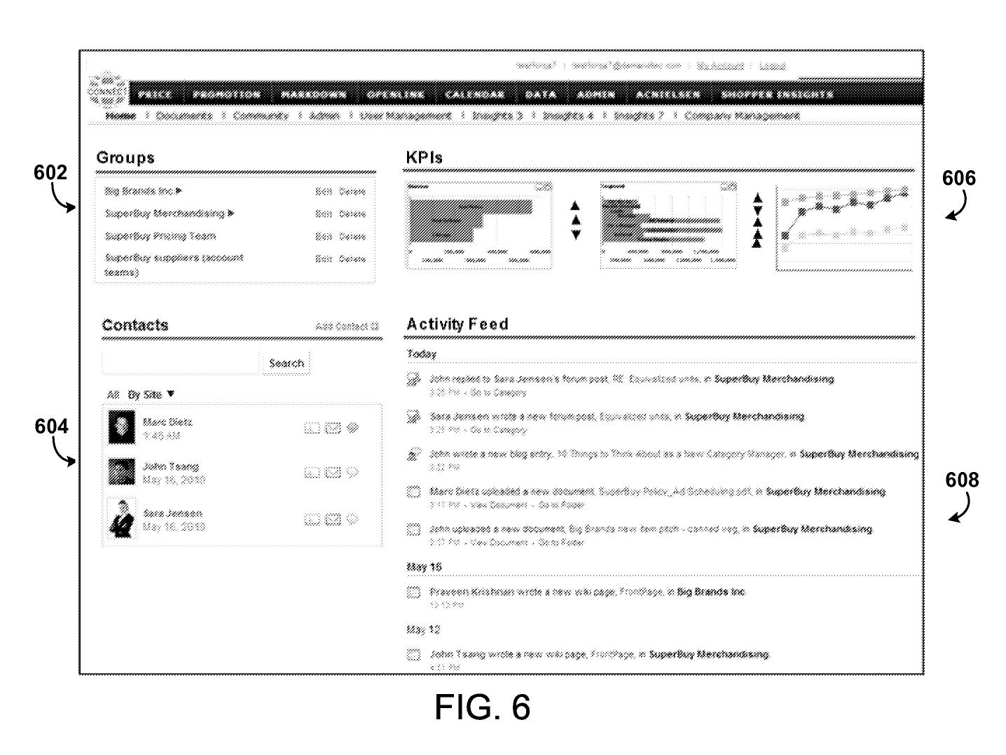

FIGS. 6 through 12 illustrate example screenshots for various features of the retail value network platform 110, in accordance with some embodiments. Note that there are numerous ways of presenting the data illustrated in these example screenshots. As such, specific embodiments of how said data is displayed are intended to be merely illustrative, and are not intended to limit the present invention.

FIG. 6 is an example screenshot for the dashboard of the retail value network platform, in accordance with some embodiment. In this example, a tabs section on the top of the screen enables a user to select an analytic, including price optimization, promotions, markdowns, data sources, consumer insights, administrative tools, and the like. At 602, the workgroups for the user are displayed. At 604, the user's contacts are presented. Analytic results (here key products insights) are also displayed, at 606. Lastly, an activity feed is presented at 608. The activity feed, workgroups, and contacts are cumulatively part of the collaboration tools.

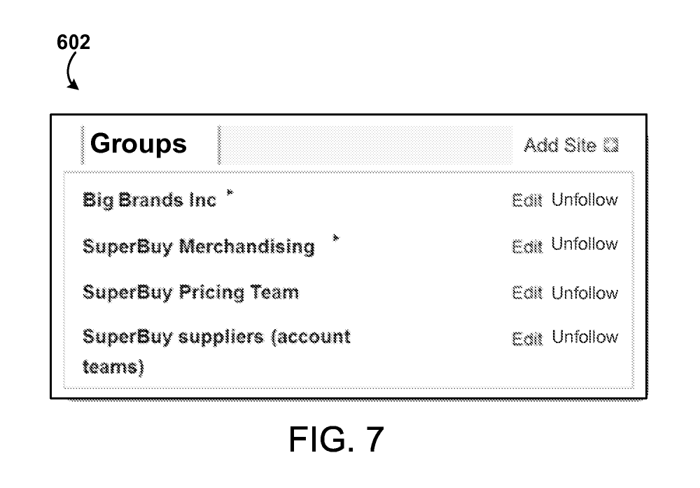

FIG. 7 is a more detailed view of the “groups” window of the dashboard, shown at 602. Here it can be seen that the user is following four separate groups, in this example. The user has the ability to edit each of the groups, unfollow a group, or add an additional group. Addition of another group may include generation of the group, or joining an existing group. If the user sets up the group, that user may control who has access to the group, and permissions that control what followers of the group are allowed to do in the group. For example, the group owner may allow some users to only read content while others have the ability to create it as well. Groups could also be used to control what analytics and content feeds a user has access to.

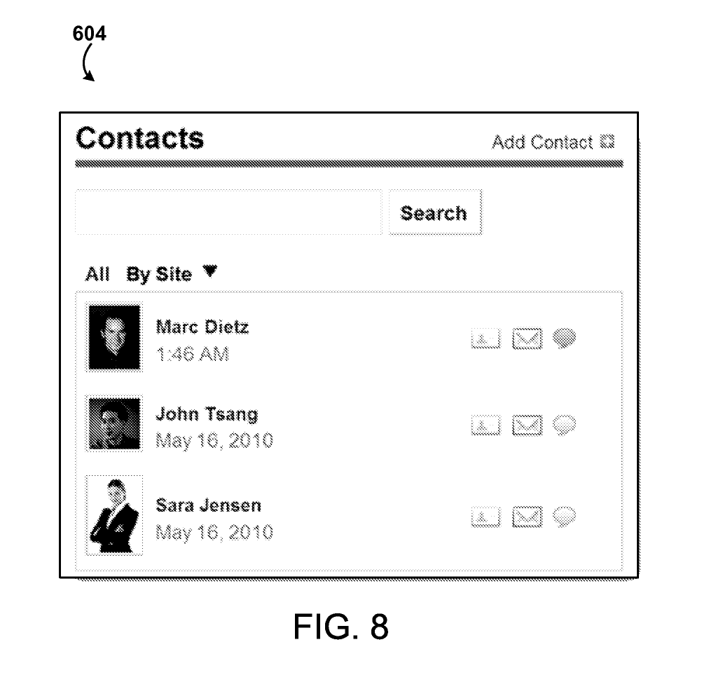

FIG. 8 is a more detailed view of the “contacts” window of the dashboard, shown at 604. This screen displays contacts associated with the user. Contacts may include individuals within the groups the user is affiliated with, or may be added individually. The user may be able to search other individuals and add them to their contacts provided there are permissions in place. The contact list also enables the user to look up greater details of her contacts, email message the contacts and instant message the contact when they are online.

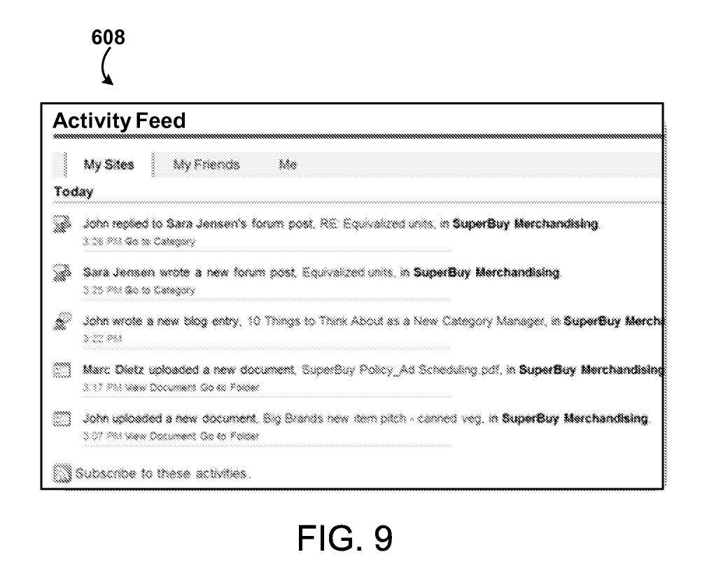

FIG. 9 is a more detailed view of the “activity feed” window of the dashboard, shown at 608. This activity feed provides the user with up-to-date information on group activity and postings, as well as status updates and relevant news. The activity feed may be sorted by sites (i.e., workgroups and newsfeeds), friends, or the users personalized content. Document updates, status updates, and comments are all illustrated on the feed, and may be readily distinguished by activity icons. The user may be able to subscribe for additional feeds, or unsubscribe from feeds, at will.

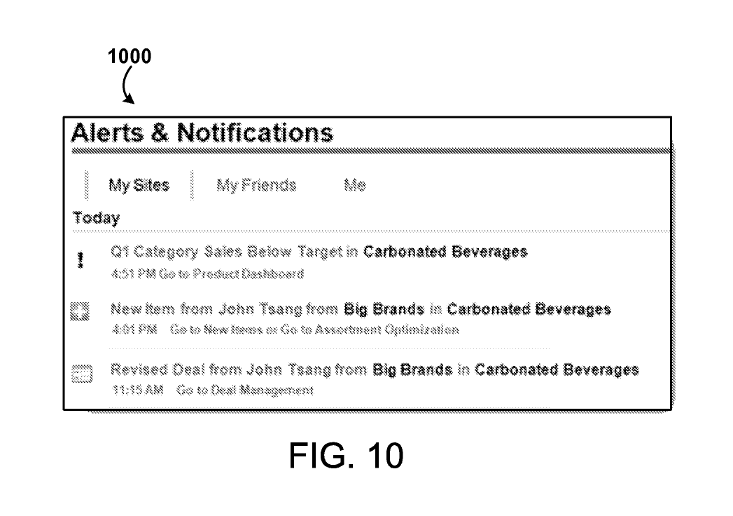

FIG. 10 illustrates an example window for “alerts and notifications”, at 1000, which may be another component of some example of the collaboration tools. Like the activity feed, alerts and notifications may be sorted by sites (i.e., workgroups and newsfeeds), friends, or the users personalized content. Alerts and notification may provide the user with important or urgent news, as well as notifications or comments directed to the user. Alerts and notifications may also be used to notify a user or group of users that an analytics job (e.g., a price optimization or consumer insights report) is complete and available for viewing.

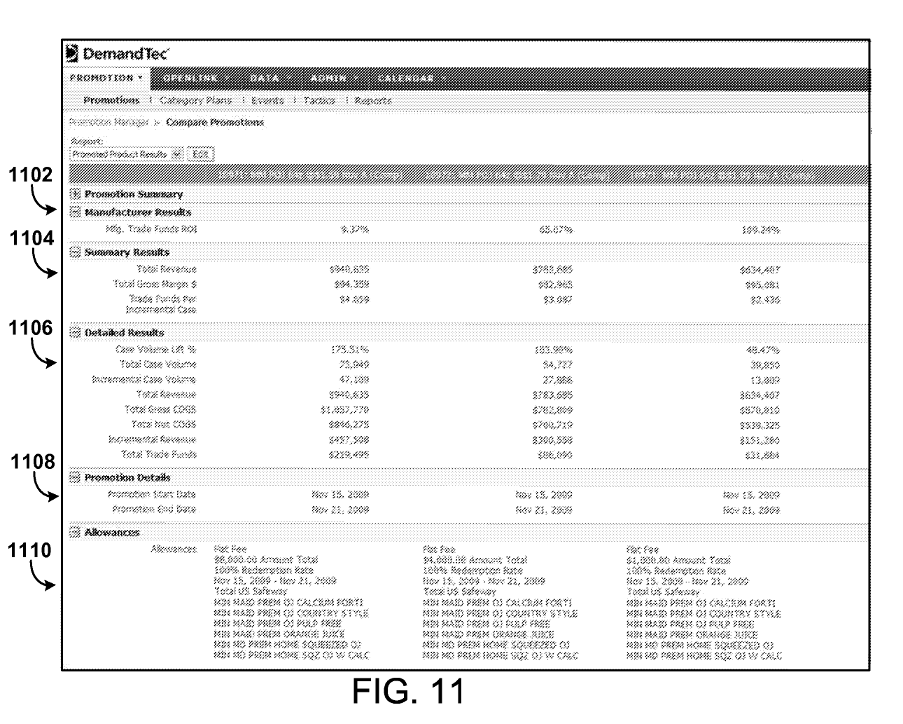

FIG. 11 is an example screenshot for a promotion analytic of the retail value network platform, in accordance with some embodiment. In this example screenshot, the user has selected the promotions tab on the top of the dashboard. The promotion analysis may include a promotion summary, a vendor's result (at 1102), summary results (at 1104), detailed results (at 1106), promotion details (at 1108) and allowances (at 1110).

In this example screenshot, three separate promotions are being compared. The three promotions being compared are proposed discounts on orange juice, each differing by 20 cents. Interestingly, the largest price reduction and the least reduced price each result in greater gross margin than the middle price reduction, in this example. In such a way the user is able to readily compare promotions in order to maximize for a business goal.

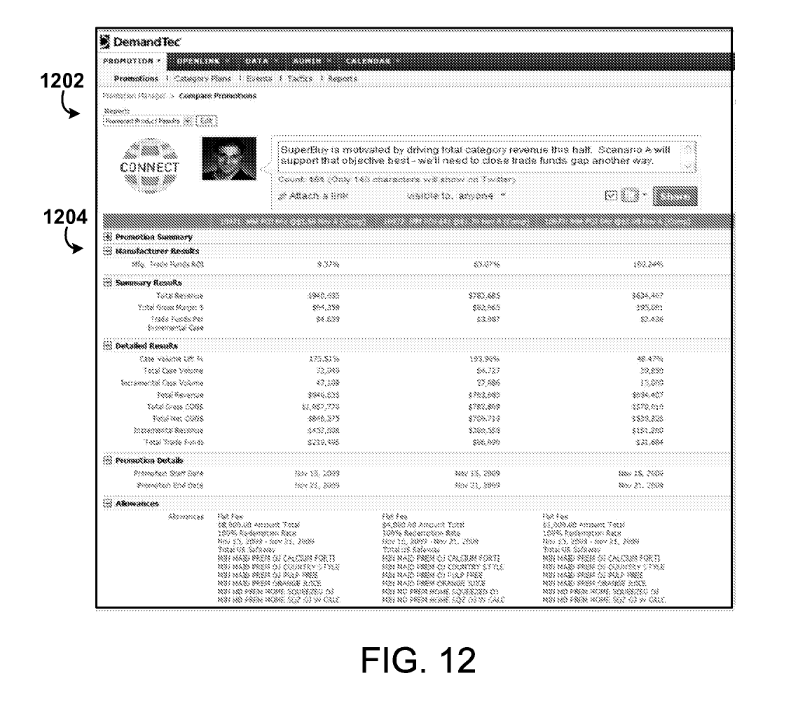

At FIG. 12, the user is able to use the collaborative tools in order to share the analytic results with others who follow the Twitter™ account of the user, in this example. Here the user is reporting out the results of the analytic, at 1202, via a “tweet”. The user links the promotional analysis results, seen at 1204, to the “tweet” for followers to view. Other individuals who follow the users Twitter™ account of the user will receive an alert on their activity feed indicating that the analytic has been performed and is available for viewing.

### IV. SYSTEM PLATFORM

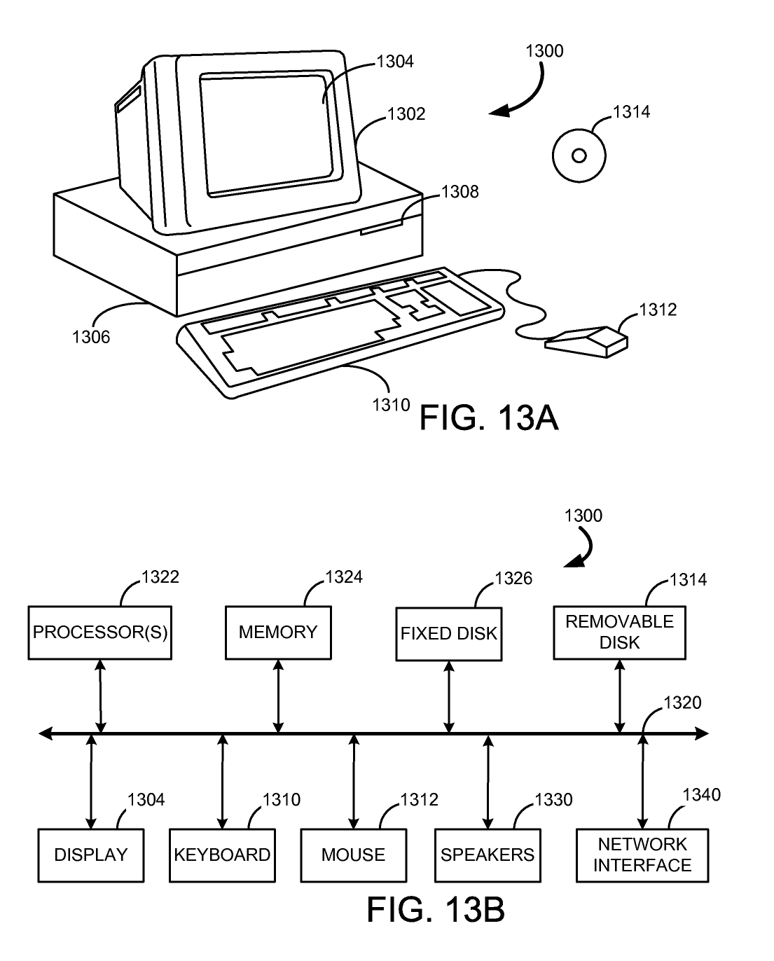

FIGS. 13A and 13B illustrate a computer system 1300, which forms part of the network 10 and is suitable for implementing embodiments of the present invention. FIG. 7A shows one possible physical form of the computer system. Of course, the computer system may have many physical forms ranging from an integrated circuit, a printed circuit board, and a small handheld device up to a huge super computer. Computer system 1300 includes a monitor 1302, a display 1304, a housing 1306, a disk drive 1308, a keyboard 1310, and a mouse 1312. Disk 1314 is a computer-readable medium used to transfer data to and from computer system 1300.

FIG. 7B is an example of a block diagram for computer system 1300. Attached to system bus 1320 are a wide variety of subsystems. Processor(s) 1322 (also referred to as central processing units, or CPUs) are coupled to storage devices, including memory 1324. Memory 1324 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 1326 is also coupled bi-directionally to CPU 1322; it provides additional data storage capacity and may also include any of the computer-readable media described below. Fixed disk 1326 may be used to store programs, data, and the like and is typically a secondary storage medium (such as a hard disk) that is slower than primary storage. It will be appreciated that the information retained within fixed disk 1326 may, in appropriate cases, be incorporated in standard fashion as virtual memory in memory 1324. Removable disk 1314 may take the form of any of the computer-readable media described below.

CPU 1322 is also coupled to a variety of input/output devices, such as display 1304, keyboard 1310, mouse 1312 and speakers 1330. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 1322 optionally may be coupled to another computer or telecommunications network using network interface 1340. With such a network interface, it is contemplated that the CPU might receive information from the network, or might output information to the network in the course of performing the above-described method steps. Furthermore, method embodiments may execute solely upon CPU 1322 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In the specification, examples of product are not intended to limit products covered by the claims. Products may for example include food, hardware, software, real estate, financial devices, intellectual property, raw material, and services. The products may be sold wholesale or retail, in a brick and mortar store or over the Internet, or through other sales methods.

In sum, the present invention provides a system and methods for a retail value network platform. The advantages of such a system include the ability to run retail analytics and collaborate with other users in order to enhance the business decision making process.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computer implemented method for a retail collaboration platform, the computer implemented method comprising:
logging into a portal;
providing a plurality of retailer and vendor analytics;
providing collaboration tools; and
interfacing the collaboration tools with the plurality of retailer analytics.

2. The computer implemented method, as recited in claim 1, further comprising:
creating at least one workgroup for collaboration, wherein a user selects which workgroup is to be created or which workgroups are to be joined from a listing of available workgroups;
generating a contact list, wherein the contact list is populated with contacts from the at least one workgroup and personal contacts of the user;
monitoring the at least one workgroup for workgroup activity;
monitoring contacts in the contact list for contact activity;
displaying the workgroup activity and the contact activity to the user;
working together within one of the at least one workgroup on a shared analytics platform to plan marketing and merchandizing activities together; and
subscribing to and receiving workgroup and industry specific news and content.

3. The computer implemented method, as recited in claim 2, further comprising:
sorting the workgroup activity into actions and alerts;
sorting the contact activities into actions and alerts;
displaying actions as an activity feed; and
displaying alerts as notifications.

4. The computer implemented method, as recited in claim 2, wherein the creating at least one workgroup includes defining a new workgroup.

5. The computer implemented method, as recited in claim 2, wherein the at least one workgroup is editable.

6. The computer implemented method, as recited in claim 2, further comprising displaying key performance indicators related to the at least one workgroup.

7. The computer implemented method, as recited in claim 2, wherein the user is at least one of a retailer, vendor and collaboration partner.

8. The computer implemented method, as recited in claim 1, wherein the plurality of retailer analytics includes promotion analysis, price optimization, product assortment, and consumer segment and market analysis.

9. The computer implemented method, as recited in claim 2, wherein each workgroup of the at least one workgroup comprises contacts from at least one retailer, at least one vendor, and at least one third party.

10. The computer implemented method, as recited in claim 2, wherein each workgroup of the at least one workgroup comprises contacts related by an industry segment.

11. A retail collaboration platform comprising:
a computer network configurable to enable logging into a portal;
analytical tools, including a computer processor, configurable to provide a plurality of retailer analytics;
a collaboration tool configurable to enable social interactions; and
an interface configurable to interface the collaboration tools with the plurality of retailer analytics.

12. The retail collaboration platform recited in claim 11, wherein the collaboration tool includes:
a group module configured to select at least one workgroup, wherein a user creates at least one workgroup or selects which workgroup to request access to from a listing of available workgroups;
a contact manager configured to generate a contact list, wherein the contact list is populated with contacts from the at least one workgroup and personal contacts of the user;
an activity manager configured to monitor the at least one workgroup for workgroup activity, and monitor contacts in the contact list for contact activity; and
a display configured to display the workgroup activity and the contact activity to the user.

13. The retail collaboration platform recited in claim 12, wherein the activity manager is configured to sort the workgroup activity into actions and alerts and sort the contact activities into actions and alerts, and wherein the display is configured to display actions as an activity feed and display alerts as notifications.

14. The retail collaboration platform recited in claim 12, wherein the creating at least one workgroup includes defining a new workgroup.

15. The retail collaboration platform recited in claim 12, wherein the at least one workgroup is editable.

16. The retail collaboration platform recited in claim 12, wherein the display is further configured to display key performance indicators related to the at least one workgroup.

17. The retail collaboration platform recited in claim 12, wherein the user is at least one of a retailer, a vendor and a partner.

18. The retail collaboration platform recited in claim 11, wherein the plurality of retail analytics includes promotion analysis, price optimization, product assortment, and consumer segment and market analysis.

19. The retail collaboration platform recited in claim 12, wherein each workgroup of the at least one workgroup comprises contacts from at least one retailer, at least one vendor, and at least one third party.

20. The retail collaboration platform recited in claim 12, wherein each workgroup of the at least one workgroup comprises contacts related by a market segment.

21. The retail collaboration platform recited in claim 12, wherein the activity manager further is enabled to provide instant messaging, threaded electronic conversations, tools for content creation, file and document repository functions, and scheduling and planning tools.
